(19) United States
(12) Patent Application Publication
(10) Pub. No.: US 2013/0074803 A1
(43) Pub. Date: Mar. 28, 2013

(54) APPARATUS AND METHOD FOR THE MAGNETIC TREATMENT OF FUEL ENTERING A FUEL BURNING APPARATUS

(71) Applicant: D. Ross Murray, Cottonwood Heights, UT (US)

(72) Inventor: D. Ross Murray, Cottonwood Heights, UT (US)

(21) Appl. No.: 13/239,890

(22) Filed: Sep. 22, 2011

(51) Int. Cl. F02M 69/46; F02M 27/00

(52) U.S. Cl. 123/456; 123/538; 137/803

(57) ABSTRACT

A device for creating a magnetic field in a fuel line of a fuel burning apparatus includes a pair of magnets each having a substantially flat north pole and a substantially flat south pole and mounted by a holder on opposite sides of the fuel line with the north pole of one magnet facing the south pole of the other magnet to create a magnetic field between the facing north and south poles, the magnetic field passing through the fuel line. The magnets are mounted so that the north pole and south pole are substantially parallel to one another and to the fuel line. The holder may include magnet brackets mounted on the fuel line by a connector, such as a strap device, extending through the brackets. Spacers can be used on the strap to properly space the magnets so they remain opposite one another.

### BACKGROUND

1. Field of the Invention

The present invention relates generally to magnetically treating fuel entering a fuel burning apparatus such as an internal combustion engine or a gas burner.

2. Related Art

The prior art is full of attempts to magnetically treat fuel entering an internal combustion engine and claims that such treatment improves mileage obtained by a vehicle using such fuel treatment. While some prior art systems have shown some mileage improvement, the results achieved by most systems is disappointing.

### SUMMARY OF THE INVENTION

According to the invention, it has been found that consistent improvement in the operation of fuel burning apparatus such as internal combustion engines or gas burners can be obtained when the fuel entering the fuel burning apparatus is treated by a magnetic field if the magnetic field is created by opposite magnetic poles located on opposite sides of the fuel line so that the fuel passes through the magnetic field created directly between the opposite magnetic poles. Thus, the invention provides a north pole on one side of the fuel line and a south pole on the opposite side of the fuel line so that a magnetic field is created between the north and south poles and the fuel is passed through this magnetic field. The opposite attracting poles of the magnets on each side of the fuel line are linked by magnetic field lines extending between the magnetic poles. This creates a strong magnetic field in the fuel line through which the fuel passing through the fuel line passes. Increases in efficiency of the fuel burning apparatus and reduction in emissions from the fuel burning apparatus can be obtained.

In one embodiment of the invention, a pair of axially magnetized ring or disc magnets is arranged with the magnets of the pair spaced and positioned on opposite sides of a fuel line with opposite poles of the magnets facing one another through the fuel line. Each of the axially magnetized ring or disc magnets has a substantially flat north pole and a substantially flat south pole. The magnets are positioned on opposite sides of the fuel line so that the substantially flat north pole of one magnet is substantially parallel to and facing the fuel line while the substantially flat south pole of the other magnet is substantially parallel to and facing the opposite side of the fuel line, and the two magnets are substantially directly opposite one another with the fuel line between the two magnets. This also positions the magnets so that the substantially flat north pole of the one magnet is also substantially parallel to and directly facing, but spaced from, the south pole of the opposite other magnet. The magnetic lines of force will flow perpendicularly from the substantially flat faces of the magnets and will flow directly between the two opposing poles of the oppositely positioned magnets, passing through the fuel line which passes between the magnets.

The invention may also include providing magnet holders, such as brackets, for positioning and holding appropriate magnets on opposite sides of a fuel line, such as a fuel line or fuel rail of an internal combustion engine or other fuel burning apparatus, to generate a magnetic field between the magnets and the fuel line passing therebetween. Each of a pair of magnets are attached to a magnet holder adapted to have a connector, such as a strap device in the form of a cable tie, passed through the bracket. The brackets, with magnets attached, are positioned on opposite sides of the fuel line and secured thereto by the strap device passing through the brackets and around the fuel line. Spacers can be positioned on the strap device between the brackets to maintain the brackets, and magnets attached thereto, on opposite sides of the fuel line. The magnets are arranged to provide a north pole on one side of the fuel line and a south pole on the opposite side of the fuel line to produce a magnetic field between the poles through the fuel line.

### BRIEF DESCRIPTION OF THE DRAWINGS

Additional features and advantages of the invention will be apparent from the detailed description which follows, taken in conjunction with the accompanying drawings, which together illustrate, by way of example, features of the invention; and, wherein:

FIG. 1 is a schematic top view of a prior art V8 vehicle internal combustion engine with fuel injection showing the fuel rails, fuel injectors, and fuel connecting lines connecting the fuel injectors to the fuel rails;

FIG. 2 is a perspective view of magnets, mounting brackets, and a connecting strap forming a magnet assembly usable with the invention;

FIG. 3 is a view of the magnet assembly of FIG. 2 in a flat orientation additionally showing spacers on the strap between the brackets;

FIG. 4 is a vertical section through a fuel line showing in elevation the magnet assembly of FIGS. 2 and 3 mounted to the fuel line;

FIG. 5 is a schematic representation as enclosed by the line labeled 5 & 6 of one side of the internal combustion engine of FIG. 1, showing one of the fuel rails, a plurality of fuel injectors, and plurality of fuel connecting lines connecting the fuel injectors to the fuel rails, and showing an arrangement of the magnet assemblies as shown in FIGS. 2, 3, and 4 mounted on each of the fuel connecting lines; and

FIG. 6 is a schematic representation as enclosed by the line labeled 5 & 6 of one side of the internal combustion engine of FIG. 1, showing one of the fuel rails, a plurality of fuel injectors, and plurality of fuel connecting lines connecting the fuel injectors to the fuel rails similar to that of FIG. 5, but showing a different arrangement of the magnet assemblies as shown in FIGS. 2, 3, and 4 so the magnet assemblies are mounted on the fuel rail rather than the fuel connecting lines.

Reference will now be made to the exemplary embodiments illustrated, and specific language will be used herein to describe the same. It will nevertheless be understood that no limitation of the scope of the invention is thereby intended.

### DETAILED DESCRIPTION OF THE ILLUSTRATED EXAMPLE EMBODIMENT

The invention includes a device and a method for creating a magnetic field in a fuel line of a fuel burning apparatus, such as an internal combustion engine or a gas burner, so that fuel passing through the fuel line passes through the magnetic field and is treated by the magnetic field. The efficiency and performance of the fuel burning apparatus is increased and the emissions, such as carbon dioxide, carbon monoxide, and hydrocarbons, are reduced. It is believed that by passing the fuel, either a liquid or a gaseous fuel, through a magnetic field, the larger fuel molecules are broken up into smaller aligned molecules by the magnetic field for better burning efficiency. A pair of magnets each having a substantially flat north pole and a substantially flat south pole are mounted on opposite sides of the fuel line with the north pole of one magnet facing the south pole of the other magnet to create a magnetic field directly between the north and south poles, which magnetic field passes through the fuel line. This arrangement and mounting of the magnets of the invention are believed to provide a stronger magnetic field through the fuel line than the various prior art arrangements of magnets and therefore, better treats the fuel passing through this magnetic field.

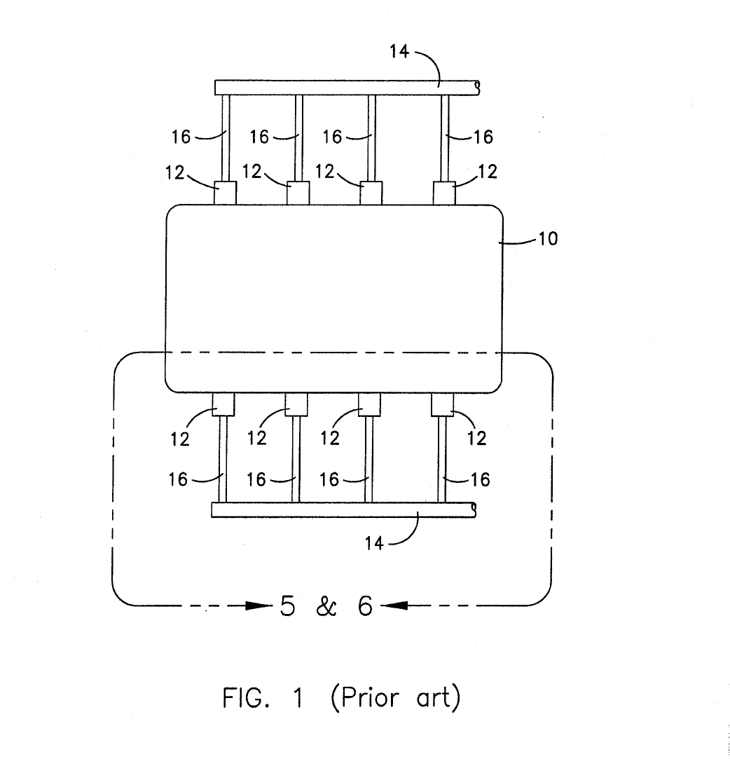

While the invention can be used with various types of fuel burning apparatus, the invention will be described and shown in use on a vehicle internal combustion engine. FIG. 1 shows a schematic top view of a prior art vehicle internal combustion engine 10 with fuel injection, such as a V8 vehicle engine. Such an engine 10 has four cylinders along each side of the engine with a fuel injector 12 for each cylinder. This provides four individual fuel injectors 12 along each side of the engine. A fuel line, in the form of fuel rails 14, carries pressurized fuel in usual manner from a fuel pump, not shown, to the engine adjacent the plurality of fuel injectors 12. Fuel connecting lines 16 are connected between each fuel injector 12 and a respective fuel rail 14 so that fuel flows from the fuel rails 14 to the fuel injectors 12. It is noted that in some smaller engines with inline cylinders, only a single fuel rail is needed as all injectors are located on the same side of the engine.

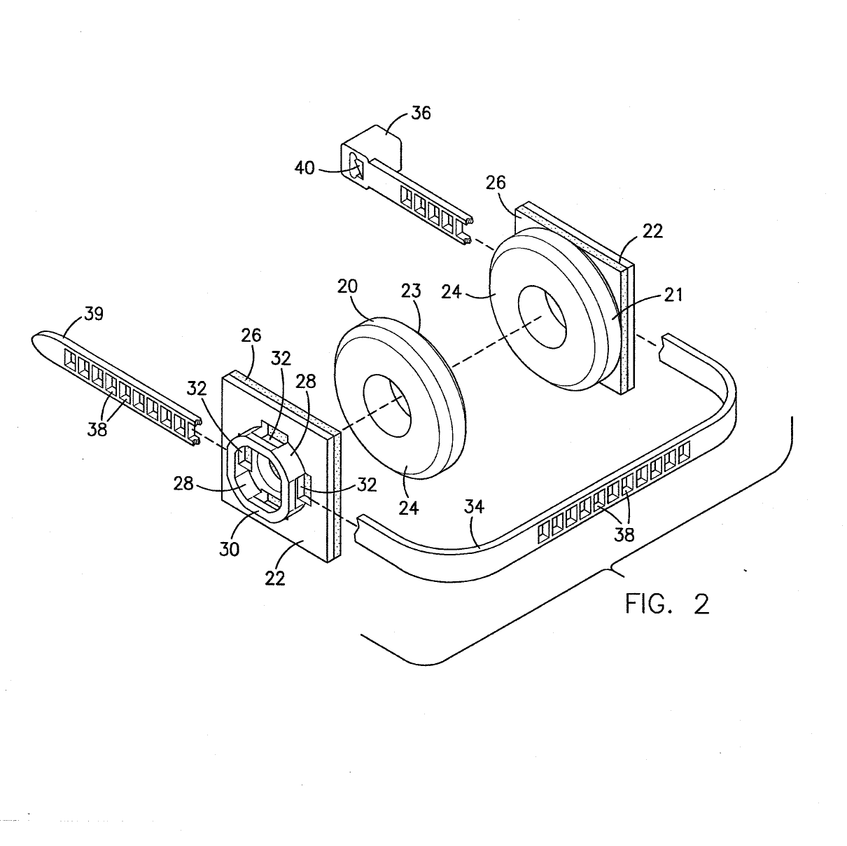

FIGS. 2-4 illustrate an example embodiment of magnets and magnet holders usable with the invention. Thus, FIGS. 2-4 show a pair of axially magnetized ring magnets 20 and 21 usable with the invention along with a pair of mounting bracket 22 for mounting the magnets. The magnets may be ceramic ring (donut) magnets, or may be made of other materials, or may be of other axially magnetized configurations such as disc magnets, rod magnets, or plate magnets. Satisfactory magnets are available from American Science & Surplus, Skokie, Ill., as number 40007 uncoated plain donut magnets having a one pound pull. These magnets are one and one-quarter inch outside diameter, three-eighths inch inside diameter and three-sixteenths inch thick. Each magnet 20 and 21 has substantially flat opposite ends or sides which provide opposite poles so that each magnet has a substantially flat north pole 23 and substantially flat south pole 24. For use, these magnets are mounted on opposite sides of the fuel line by any satisfactory magnet holders so that the north pole of one magnet is facing and directly opposite the south pole of the other magnet. In this illustrated example embodiment, the magnet holders may include mounting brackets and the mounting brackets 22 may be a commercially available 1 inch×1 inch mounting base part number 296 153 manufactured by Commercial Electric and distributed by Home Depot U.S.A., Inc. of Atlanta Ga. Such mounting brackets each have a substantially flat side with a pressure sensitive adhesive 26 thereon. The mounting bracket comes with a peel off cover, not shown, over the adhesive which is removed by the user to expose the adhesive 26. Each mounting bracket also has raised ribs 28 extending from the side opposite the substantially flat adhesive side with a central member 30 connecting the extended ends of ribs 28 to form openings 32 through which a strap, such as a cable tie 34, can be inserted and extended therethrough. The intended use for these commercially available mounting bases is to adhesively attach the base to a wall or baseboard or other object, such as a desk or entertainment center, and to then pass a cable tie 34 through opposite openings 32 to secure and hold electrical cables, such as computer cables, sound system cables, video system cables, etc., in the cable tie, in desired neat out of the way places. However, applicant has found that magnets 20 and 21, as illustrated, can be adhesively attached to these mounting bases, rather than the mounting bases being adhesively adhered to a wall or other surface, and that these mounting bases can provide mounting brackets for the magnets. When securing a magnet to a bracket, the cover over the adhesive 26 is removed and one of the substantially flat ends or sides of the magnet is adhered to the bracket by the adhesive. This is shown in FIGS. 2 and 4 with FIG. 2 showing magnet 21 adhered to a bracket 22 and showing magnet 20 spaced from bracket 22 ready to be secured to the bracket 22 by adhesive 26 as magnet 20 is move into contact with the adhesive 26. FIG. 4 shows both magnets 20 and 21 secured to separate brackets 22.

With the magnets secured to the brackets 22, a cable tie or other strap device can be used to mount and position the magnets on opposite sides of a fuel line. A cable tie, such as cable tie 34 illustrated, is a well known elongate strap device having an elongate body with a buckle mechanism 36 at one end and with ribs or holes 38 along the length or a portion of the length of the body. The end 39 opposite the buckle mechanism end can be inserted into and through a buckle opening 40 and can be pulled through a desired amount to form a loop of desired size. A ratchet in the buckle interacts with the ribs or holes 38 along the length of the tie as the tie is pulled through the buckle mechanism and prevents reverse movement of the tie back through the buckle mechanism. A cable tie with elongate body sized to fit through bracket openings 32, and eight inches in length, is cable tie part number 295 813 manufactured by Commercial Electric and distributed by Home Depot U.S.A., Inc. of Atlanta Ga.

In use of the described illustrated example magnet assembly of the invention, the brackets 22 holding the magnets 20 and 21, can be secured around a fuel line by passing a cable tie 34 through opposite openings 32 in each bracket and placing the cable tie around the fuel line to be treated, and tightening the cable tie around the fuel line so as to position the brackets and magnets on opposite sides of the fuel line. This can be enough to position and hold the magnets on opposite sides of a fuel line, particularly if the fuel line is rectangular so that the magnets rest against opposite flat fuel line surfaces. However, where the fuel line is circular, as is common, provision has to be made to maintain the brackets and magnets on opposite sides of the fuel line. Otherwise, the brackets can slide along the cable tie and come out of position.

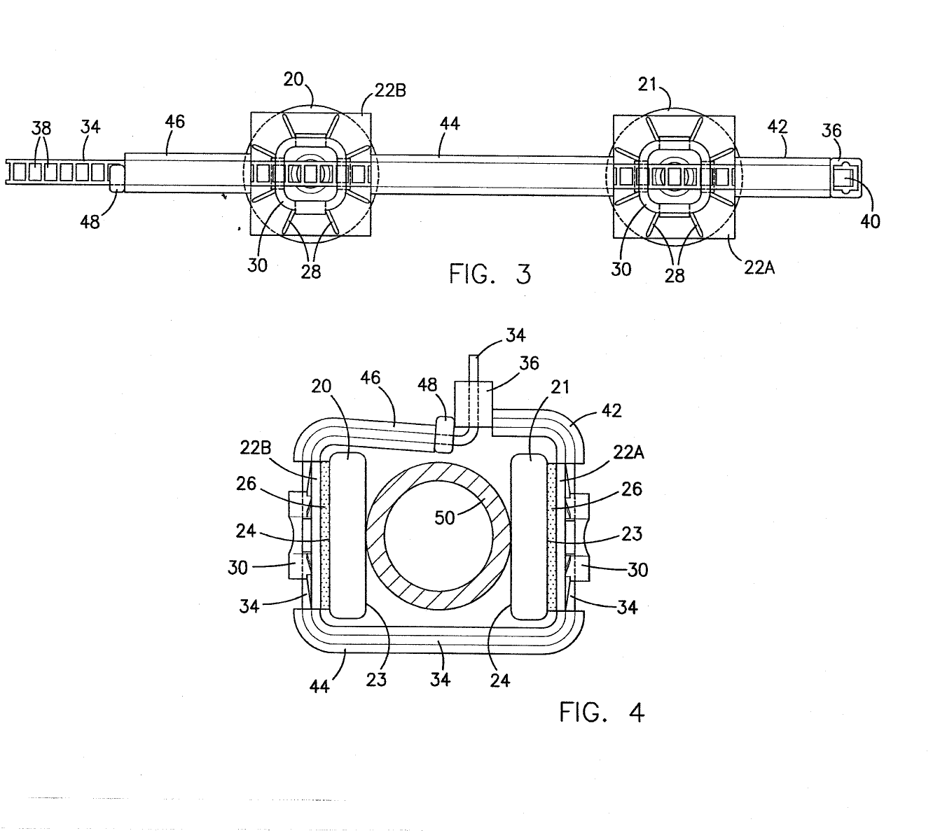

In order to ensure that the magnets 20 and 21 and brackets 22 remain correctly positioned opposite and facing one another when secured on a fuel line, spacers between the brackets can be provided in conjunction with the cable tie. FIGS. 3 and 4 show pieces of tubing, such as flexible one and one-eighth inch diameter vinyl plastic tubing, placed on the cable tie 34 (cable tie 34 extends inside the tubing pieces) between the brackets 22, shown in FIGS. 3 and 4 as brackets 22A and 22B, so that when attached around a fuel line, the brackets 22 with attached magnets remain opposite one another to hold the facing substantially flat poles of the magnets substantially parallel to one another and to the fuel line. Care has to be taken that the opposite faces of the magnets have opposite polarity so that a north pole faces a south pole. The lengths of the tubing pieces used will depend upon the diameter of the fuel line on which the magnets are mounted.

A preassembled magnet assembly ready to be secured to a fuel line of a particular diameter is shown in FIG. 3. Tubing piece 42 extends along cable tie 34 between the buckle mechanism 36 and a first magnet bracket 22A. Tubing piece 44 extends along cable tie 34 between magnet brackets 22A and 22B. Tubing piece 46 extends along cable tie 34 between magnet brackets 22B and a tube holder 48, which holds tubing piece 46 substantially against bracket 22B, and keeps tubing piece 48 from sliding off cable tie 34 prior to and during installation of the magnet assembly on the fuel line. Tube holder 48 can be a split shot, such as a fishing line weight, secured in a predetermined location along the cable tie 34. With this arrangement of tubing pieces forming spacers, the assembly of FIG. 3 can be wrapped around a fuel line of predetermined diameter and the end 39 of the cable tie inserted through the buckle mechanism opening 40 and pulled through the buckle mechanism to tighten the cable tie around the fuel line to bring the buckle mechanism 36 into contact with the tube holder 48, as shown in FIG. 4. Once tightened, the extra length of the end of the cable tie extending from the buckle mechanism can be cut off. With the cable tie 34 tightened as shown in FIG. 4, the cable tie and the spacers should position the magnets 20 and 21 relatively tightly against opposite sides of the fuel line 50 and maintain the magnets opposite one another because the brackets 22A and 22B cannot slide on cable tie 34. As shown in FIG. 4, the length of the combination of tube pieces 42 and 46 along with tube holder 48 and buckle mechanism 36 should be substantially the same as the length of tubing piece 44. In this way, the magnets are maintained in a position directly opposite one another. While the entire assembly might rotate around fuel line 50, the magnets will still be maintained in desired position facing one another. While the illustrated magnet assembly and mounting system for mounting the magnet assembly on a fuel line has been found satisfactory and easy to install, various other magnet assemblies and mounting systems for the magnets with respect to a fuel line can be used. For example, magnet holders may be molded of a nonmagnetic plastic material in a shape to fit around half of a fuel line and to hold one of the pair of magnets with a pole of the magnet substantially parallel to the fuel line and in a position so that when one holder is connected to another holder on an opposite side of the fuel line, two magnets are held on opposite sides of the fuel line with the magnetic pole of one magnet facing the magnetic pole of the opposite magnet. The holders can be connected by connectors such as plastic screws, clips, strap devices, etc. The important aspect of the invention is that two magnets are mounted on opposite sides of the fuel line so that a north magnetic pole of one magnet faces a south magnetic pole of the other magnet.

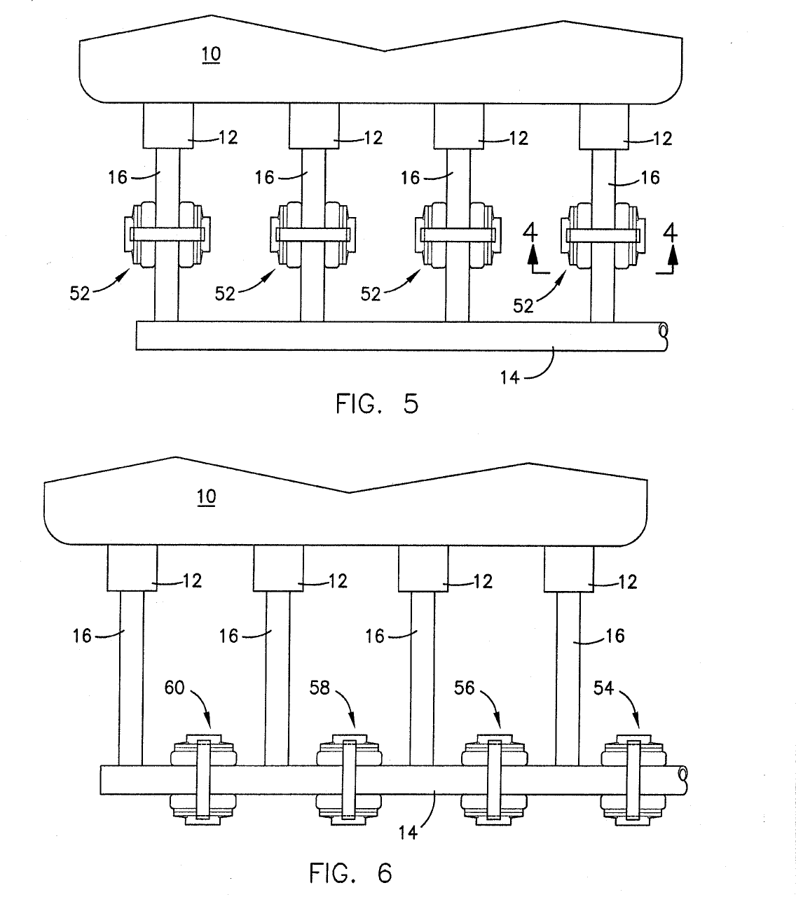

FIG. 5 shows one side of the engine 10 of FIG. 1, and illustrates one way that the magnet assemblies of the invention can be arranged in respect to a fuel injected vehicle internal combustion engine. In the arrangement of FIG. 5, magnet assemblies 52 as shown in FIGS. 2-4 are attached to each of the fuel connecting lines 16 connecting the fuel injectors 12 to the fuel rail 14. With this arrangement, the fuel entering each fuel injector 12 is treated by flowing through the magnetic field when flowing from the fuel rail to the injector. Since the fuel connecting lines 16 are generally short, the magnetic treatment of the fuel occurs just before the fuel enters the fuel injectors.

FIG. 6 shows the same side of the engine 10 of FIG. 1 as does FIG. 5, but illustrates a different arrangement of the magnet assemblies. In the arrangement of FIG. 6, the magnet assemblies as shown in FIGS. 2-4 are attached to the fuel rail 14. As shown, a first magnet assembly 54 is mounted on the fuel rail 14 upstream of the first fuel connecting line 16 connecting the first fuel injector 12 to the fuel rail 14. The magnetic field created by this first magnet assembly 54 will treat all fuel flowing through the fuel rail to the fuel injectors. The second magnet assembly 56 is mounted on the fuel rail 14 downstream of the first fuel connecting line 16 but upstream of the second fuel connecting line 16. The magnetic field created by this second magnet assembly will treat all fuel flowing through the fuel rail except that which was directed from the fuel rail to the first fuel injector by the first fuel connecting line 16. The third magnet assembly 58 is mounted on the fuel rail 14 downstream of the second fuel connecting line 16 but upstream of the third fuel connecting line 16. The magnetic field created by this third magnet assembly will treat the fuel still flowing through the fuel rail to the third and fourth fuel injectors. The fourth magnet assembly 60 is mounted on the fuel rail 14 downstream of the third fuel connecting line 16 but upstream of the fourth and last fuel connecting line. The magnetic field created by this fourth magnet assembly will treat the fuel flowing through the fuel rail and to the fourth fuel injector. It should be noted that by the time the fuel has gotten to the fourth injector, that fuel has been through four magnetic fields, i.e., each of the magnetic fields created by each of the four magnet assemblies 54, 56, 58, and 60.

It is believed that best results are obtained when fuel is treated by the magnetic field close to the fuel entering the fuel burning apparatus, i.e., when used with a fuel injected internal combustion engine, being treated close to entering the injector. Thus, where the fuel connecting lines 16 are long enough and are exposed so that the magnet assemblies can be placed on such fuel connecting lines, the arrangement of FIG. 5 provides treatment to the fuel just before entering the fuel injectors. However, as indicated, the fuel connecting lines 16 are often short, in some cases too short for the mounting of the magnet assemblies, or the fuel connecting lines 16 may not be configured to enable or may pass through a tight area without room for attaching the magnet assemblies. In such cases, the arrangement of FIG. 6 can be used and will still provide the magnetic fields close to the injectors. Alternatively, since all of the fuel entering the fuel injectors pass through the first magnet assembly 54 in the arrangement of FIG. 6, such magnet assembly 54 can be used without the additional magnet assemblies 56, 58, and 60 further downstream on the fuel rail. However, with such alternative arrangement, the treatment of the fuel will not be as close to the second, third, and fourth injectors as to the first fuel injector and may not provide the same improvement results as when using the multiple magnet assemblies. Since FIGS. 5 and 6 show only one side of the engine in FIG. 1, where two fuel rails are used, as shown in FIG. 1, the arrangement of either FIG. 5 or FIG. 6 will be duplicated for the other side of the engine. In some instances it may be difficult or impossible to reach either a fuel rail or a fuel connecting line or have room for magnet mounting to either the fuel rail of fuel connecting line. In such case, one or more magnet assemblies can be mounted along the fuel line at any accessible location. Where the engine on which the magnet assembly is mounted is not fuel injected, one or more magnet assemblies of the invention may be mounted on the fuel line leading to the carburetor, preferably close to the carburetor. Similarly, for other fuel burning apparatus on which the magnet assembly may be used, such as gas burning furnaces, stoves, etc., the magnet assembly of the invention may be mounted on the fuel line leading to such other fuel burning apparatus.

It has been found important for the best results that the magnets be mounted with opposite pole faces facing each other, i.e., a north pole facing a south pole, so that a magnetic field is created in the fuel line directly between the opposing magnetic faces. The magnets should have substantially flat faces mounted parallel to each other and parallel to the fuel line so that the magnetic field extends directly through the fuel line from one opposing face to the opposite opposing face. Thus, as shown in FIG. 4, magnet 20 has north pole 23 facing the fuel line 50 and facing the magnet 21 on the opposite side of the fuel line. Conversely, magnet 21 has south pole 24 facing fuel line 50 and facing magnet 20 on the opposite side of the fuel line. With this arrangement, a strong magnetic field is formed between the substantially directly facing magnetic poles 23 and 24 of magnets 20 and 21, respectively, with this strong magnetic field extending through fuel line 50 between the magnets. Any magnet holders that hold and position the magnets in this arrangement with respect to a fuel line can be used.

Tests conducted using the device and method of the invention showed improvements in miles per gallon obtained from the vehicles tested and a reduction in emissions and increase in efficiency of a propane stove tested.

Test 1

A diesel box truck with a 4.9 liter diesel engine was tested. The average miles per gallon over a six month period prior to installing the device of the invention was between 8 and 8.5 miles per gallon. After installing the device of the invention on the fuel connecting lines connecting the injectors to the fuel line as shown in FIG. 5, and testing for three weeks, the average miles per gallon were 12.962, a increase of 4.46 miles per gallon.

Test 2

A pickup truck was driven 314 miles from Salt Lake City to St. George, Utah, which used 23.8 gallons of gasoline. The return trip of 315 miles along the same route, but in the opposite direction from St. George back to Salt Lake City, but with the device of the invention installed on the truck, used 20.5 gallons of gasoline. Thus, the invention saved about 3.3 gallons of gasoline and increased the miles per gallon from about 13.19 miles per gallon to about 15.37 miles per gallon.

Test 3

Three freeway round trips averaging 76.4 miles each between Salt Lake City and Provo, Utah, were made in a 1980 Ford LTD having an eight cylinder carbureted engine with the magnets of the invention mounted on a fuel line leading from the fuel pump to the carburetor. The freeway between Salt Lake City and Provo is essentially flat but with one approximately two mile section of 6% grade. The average miles per gallon obtained was 25.9 miles per gallon. This was an increase of about 32.7% over the established base line of 19.52 miles per gallon for the same vehicle without the device of the invention. Similarly, three freeway round trips averaging 79.8 miles each between Salt Lake City and Ogden, Utah, in the same vehicle with the device of the invention were made with an average miles per gallon obtained of about 26.4 miles per gallon. This was an increase of about 36.1% over the established base line of 19.39 miles per gallon for the same vehicle without the device of the invention. The freeway between Salt Lake City and Ogden is essentially flat. Similarly, three freeway round trips averaging 160.1 miles between Salt Lake City and Logan, Utah, in the same vehicle were made with an average miles per gallon obtained of about 19.3 miles per gallon. This was an increase of about 7.1% over the established base line of 18.02 miles per gallon for the same vehicle without the device of the invention. The freeway between Salt Lake City and Logan is essentially flat for two thirds of the distance with steep mountainous travel over the other third. In the above tests, every effort was made to replicate identical runs. The runs were made at freeway speeds, averaging fifty miles per hour, but ranging from forty five miles per hour to sixty miles per hour, with the exception of turnaround stops and minor travel to and from the freeway. The same driver made each set of runs, the road conditions and weather conditions were the same, the fuel was from a single supply tank, and the runs were made at the same time of day with essentially unchanged traffic conditions.

Test 4

Emissions from a propane stove were tested. The propane stove used one source of propane as fuel. A tee valve at the propane bottle outlet separated the two source lines leading to the stove. Each line had a shut off valve so as to allow one line at a time to supply fuel to the stove. One line was without obstructions or additional fixtures except for the tee valve and the shut off valve. The other line had the same tee valve and shut off valve, and additionally had the device of the invention installed on the line. The carbon dioxide emissions were 3.6% with the invention compared to 5.8% without the invention. The carbon monoxide emissions were 460 PPM with the invention compared to 682 PPM without the invention. The efficiency was 63.3% with the invention compared to 47.4% without the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

1. A device for creating a magnetic field in a fuel line of a fuel burning apparatus, comprising:
a pair of magnets each having a substantially flat north pole and a substantially flat south pole; and
a magnet holder adapted to mount the magnets of the pair on opposite sides of the fuel line with the north pole of one magnet directly facing the south pole of the other magnet to create a magnetic field between the facing north and south poles which magnetic field passes through the fuel line which is positioned between the facing north and south poles.

2. A device in accordance with claim 1, wherein the magnets are axially magnetized.

3. A device in accordance with claim 2, wherein the magnets are chosen from the group consisting of axially magnetized ring magnets, axially magnetized disc magnets, axially magnetized rod magnets, and axially magnetized plate magnets.

4. A device in accordance with claim 1, wherein the magnet holder includes a bracket for each magnet and a connector securing the brackets on opposite sides of the fuel line.

5. A device in accordance with claim 4, wherein the magnets are adhesively secured to the respective brackets.

6. A device in accordance with claim 5, wherein the connector is a strap device.

7. A device in accordance with claim 6, wherein the fuel burning apparatus is an internal combustion engine.

8. A device in accordance with claim 7, wherein the fuel line is a fuel rail.

9. A device in accordance with claim 7, wherein the fuel line connects an internal combustion engine fuel injector to the fuel rail.

10. A device in accordance with claim 7, wherein the internal combustion engine is a multiple cylinder engine with a fuel injector for each cylinder of the multiple cylinders, wherein a fuel line connects each fuel injector to a fuel rail, and wherein a pair of magnets is mounted on each fuel line between the fuel injector and the fuel rail.

11. A device in accordance with claim 7, wherein the internal combustion engine is a multiple cylinder engine with a fuel injector for each cylinder of the multiple cylinders, at least one fuel rail forming the fuel line, a plurality of fuel connecting lines, each fuel connecting line connected to the at least one fuel rail and one of the multiple fuel injectors, the connections of the fuel connecting lines to the at least one fuel rail being spaced along the at least one fuel rail, and wherein a pair of magnets is mounted on the at least one fuel rail upstream of the connection of each fuel connecting line to the fuel rail.

12. A device in accordance with claim 11, wherein a pair of magnets is mounted on the at least one fuel rail upstream of the connection of any fuel connecting line to the at least one fuel rail and an additional pair of magnets is connected between the connections of any two adjacent fuel connecting lines to the at least one fuel rail.

13. A device in accordance with claim 1, wherein the fuel burning apparatus is an internal combustion engine.

14. A device in accordance with claim 13, wherein the fuel line is a fuel rail.

15. A device in accordance with claim 13, wherein the fuel line connects an internal combustion engine fuel injector to the fuel rail.

16. A device in accordance with claim 13, wherein the internal combustion engine is a multiple cylinder engine with a fuel injector for each cylinder of the multiple cylinders, wherein a fuel line connects each fuel injector to a fuel rail, and wherein a pair of magnets is mounted on each fuel line between the fuel injector and the fuel rail.

17. A device in accordance with claim 13, wherein the internal combustion engine is a multiple cylinder engine with a fuel injector for each cylinder of the multiple cylinders, at least one fuel rail forming the fuel line, a plurality of fuel connecting lines, each fuel connecting line connected to the at least one fuel rail and one of the multiple fuel injectors, the connections of the fuel connecting lines to the at least one fuel rail being spaced along the at least one fuel rail, and wherein a pair of magnets is mounted on the at least one fuel rail upstream of the connection of each fuel connecting line to the at least one fuel rail.

18. A device in accordance with claim 17, wherein a pair of magnets is mounted on the at least one fuel rail upstream of the connection of any fuel connecting line to the at least one fuel rail and an additional pair of magnets is connected between the connections of any two adjacent fuel connecting lines to the at least one fuel rail.

19. A method for creating a magnetic field in a fuel line of a fuel burning apparatus, comprising the steps of:
obtaining a pair of magnets each magnet of the pair having a substantially flat north pole and a substantially flat south pole; and
mounting the magnets of the pair on opposite sides of the fuel line with the north pole of one magnet directly facing the south pole of the other magnet to create a magnetic field between the facing north and south poles which magnetic field passes through the fuel line which is positioned between the facing north and south poles.

20. A method in accordance with claim 19, wherein the fuel burning apparatus is a multiple cylinder, fuel injected internal combustion engine with a fuel injector for each cylinder of the multiple cylinders, wherein a fuel line connects each fuel injector to a fuel rail, and wherein the step of mounting the magnets of the pair of magnets on opposite sides of the fuel line includes the step of mounting a pair of magnets on each fuel line between the fuel injector and the fuel rail.

21. A method in accordance with claim 19, wherein the fuel burning apparatus is a multiple cylinder, fuel injected internal combustion engine with a fuel injector for each cylinder of the multiple cylinders and at least one fuel rail forming the fuel line, wherein a fuel connecting line connects each of the multiple fuel injectors to the at least one fuel rail, with the connections of the fuel connecting lines to the at least one fuel rail being spaced along the at least one fuel rail, and wherein the step of mounting the magnets of the pair of magnets on opposite sides of the fuel line includes the step of mounting a pair of magnets on the at least one fuel rail upstream of the connection of each fuel connecting line to the at least one fuel rail.

22. A method in accordance with claim 21, wherein the step of mounting the magnets of the pair of magnets on opposite sides of the fuel line includes the step of mounting a pair of magnets on the at least one fuel rail upstream of the connection of any fuel connecting line to the at least one fuel rail and mounting an additional pair of magnets to the at least one fuel rail between the connections of any two adjacent fuel connecting lines to the at least one fuel rail.
